(19) United States
(12) Patent Application Publication
(10) Pub. No.: US 2007/0136135 A1
(43) Pub. Date: Jun. 14, 2007

(54) PERMANENT CATEGORY-BASED PROMOTION FOR CREDIT CARD USAGE

(75) Inventors: Julie Loeger, Riverwoods, IL (US); Margaret H. Georgiadis, Riverwoods, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: DISCOVER FINANCIAL SERVICES LLC, Riverwoods, IL (US)

(21) Appl. No.: 11/610,434

(22) Filed: Dec. 13, 2006

Related U.S. Application Data
(60) Provisional application No. 60/749,840, filed on Dec. 13, 2005.

(51) Int. Cl. G06Q 30/00

(52) U.S. Cl. 705/14

(57) ABSTRACT

A series of time-bounded bonus rewards programs is disclosed for offering by a financial institution. Consumers enroll in each program and are thereafter provided bonus rewards on consumer purchases with a credit card on goods and services from one or more select merchant categories until the program's expiration. These bonus rewards are in addition to or in place of standard rewards the financial institution offers its customers. The selected merchant categories of the bonus rewards programs are relevant to the consumer in the given time frame in that they provide goods and services according to consumers' needs for that time of year. Incentives are thus provided to consumers to increase their use of the financial institution's credit card by providing bonus rewards on purchases that fit consumers' needs within the time frame of the program.

### CROSS-REFERENCE TO RELATED APPLICATIONS

This patent application claims the benefit of U.S. Provisional Patent Application No. 60/749,840, filed Dec. 13, 2005.

### BACKGROUND OF THE INVENTION

As credit cards, debit cards, and other alternatives to currency have grown in popularity, the competition among the institutions that provide these financial instruments has also increased. Today, many consumers choose a credit card, debit card, or the like, based on the financial incentive to the consumer for using such a card. For example, some credit cards offer low interest rates on purchases that are not paid off within the purchase month, while other credit cards offer miles or points in frequent flyer programs.

One popular incentive offered to consumers of credit cards is a cash or cash-equivalent reward as a percentage of the consumer's purchases. Generally, such cash rewards systems provide a percentage of the dollar amount of the total purchases made by a consumer as a reward. Because there are many different rewards programs offered by financial institutions, it is desirable to provide a distinguishing feature to attract consumers. Previously, some financial institutions have offered promotional bonus rewards for purchases in particular merchant categories, such as gas stations or grocery stores. However, these previous promotions are generally short-lived, so that when a promotion expires, there is no further opportunity for the consumer to earn bonus rewards. Further, these previous promotions are typically provided in an ad hoc manner, so there is no predictability for the consumer as to when-or if-a promotion may occur.

### BRIEF SUMMARY OF THE INVENTION

The invention provides a preferably continuous series of bonus rewards programs offered by a financial institution, that provide bonus rewards on consumer purchases with a credit card (or some other financial alternative offered by the financial institution) on goods and services from select merchant categories within a given time frame. The bonus rewards programs preferably run in succession without any waiting period in between. These bonus rewards are in addition to or in place of standard rewards the financial institution offers its customers. The select merchant categories of the bonus rewards programs are relevant to the consumer in the given time frame because they provide goods and services according to consumers' needs for that time of year. For example, the financial institution may provide bonus rewards on the consumers' purchases of school supplies from select merchants in the fall coinciding with the start of the new school year. Thus, embodiments of the present invention provide incentives to consumers to increase their use of the financial institution's credit card by providing bonus rewards on purchases that fit consumers' needs within the time frame of the program. Consumers' increased use of these bonus rewards programs results in increased card usage and improved customer loyalty, which drives incremental sales and translates into profits for the financial institution through finance charges, interchange revenue and consumer fees.

In one aspect, a method is provided for using a financial alternative to currency to participate in one or more bonus rewards programs offered by a financial institution, the bonus rewards programs being offered in addition to a standard rewards program, the method comprising enrolling in a first bonus rewards program of a plurality of sequential bonus rewards programs offered by the financial institution, the first bonus rewards program being associated with a first category of merchants, purchasing goods or services, using the financial alternative to currency, from a merchant within the first category of merchants, and receiving a bonus reward from the financial institution based on the value of the purchased goods or services, wherein the reward received for the purchases under the first bonus rewards program is of a greater value than a reward received for the purchase under the standard rewards program.

In another aspect, a method is provided for implementing a bonus rewards program to one or more consumers for using a financial alternative to currency offered by a financial institution, the bonus rewards program being implemented in addition to a standard rewards program, the method comprising, determining a first category of merchants to associate with a first bonus rewards program of a plurality of sequential bonus rewards programs, accepting enrollment from a consumer to participate in the first bonus rewards program, receiving information corresponding to a purchase transaction made by the consumer with the financial alternative to currency at a merchant within the first category of merchants, and awarding the consumer with a bonus reward based on the value of the purchase transaction, wherein the reward awarded for the purchase under the first bonus rewards program is a greater value than a reward awarded for the purchase under the standard rewards program.

In still another aspect, a system is provided for implementing a series of bonus rewards programs, each bonus rewards program being offered to one or more consumers for using a financial alternative to currency offered by a financial institution, the bonus rewards program being implemented in addition to a standard rewards program, the system comprising, a network of merchants comprising a plurality of categories of merchants, a program sequencer for selecting a first category of merchants from the plurality of categories for a first bonus rewards program, determining an active timeframe for the first bonus rewards program, selecting a second category of merchants from the plurality of categories for a second bonus rewards program, and determining an active timeframe for the second bonus rewards program, the active timeframe of the second bonus rewards program disjoint from the active timeframe for the first bonus rewards program, an enrollment engine for accepting enrollment from consumers into the first bonus rewards program, a database containing purchasing transaction information for consumers enrolled in the first bonus rewards program and the standard rewards program; and a rewards processing engine for determining that a purchase transaction was made by an enrolled consumer at a merchant in the first category of merchants during the active timeframe of the first bonus rewards program, and for awarding bonus rewards based on the purchase transaction value, the bonus rewards value exceeding the value of rewards under the standard rewards program.

### BRIEF DESCRIPTION OF THE SEVERAL VIEWS OF THE DRAWINGS

While the appended claims set forth the features of the present invention with particularity, the invention and its advantages are best understood from the following detailed description taken in conjunction with the accompanying drawings, of which:

FIG. 1 is a flow diagram illustrating a method for enrolling in a series of bonus rewards programs, in accordance with an embodiment of the invention;

FIG. 2 is a flow diagram illustrating a method for accepting enrollment in a series of bonus rewards programs, in accordance with an embodiment of the invention;

FIG. 3 is a flow diagram contemplating different ways for both a consumer to enroll, and a financial institution to accept enrollment, into a series of bonus rewards programs;

FIG. 4 is a general overview of the operation of a method and system contemplated by an embodiment of the present invention;

FIG. 5 is a general overview of the operation of a method and system contemplated by an embodiment of the present invention; and

FIG. 6 is a general overview of the operation of a method and system contemplated by an embodiment of the present invention.

### DETAILED DESCRIPTION OF THE INVENTION

Embodiments of the present invention provide a series of bonus rewards programs offered from a financial institution, that provide bonus rewards on consumer purchases with a credit card (or some other financial alternative offered by the financial institution) on goods and services from select merchants and/or merchant categories within a given time frame. These bonus rewards are in addition to or in place of standard rewards the financial institution offers its customers. Rewards can take any of several forms including cash, points, or miles in frequent flyer programs. Merchants include providers of goods or services, as well as recreational facilities, entertainment venues, educational and cultural institutions, health care providers, or any other entity that accepts payment via the financial institution.

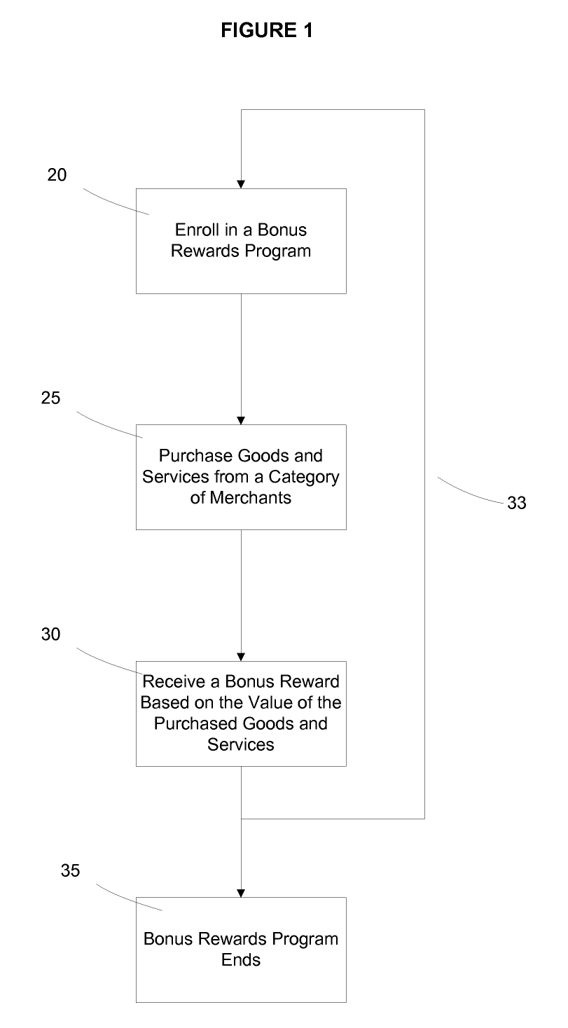

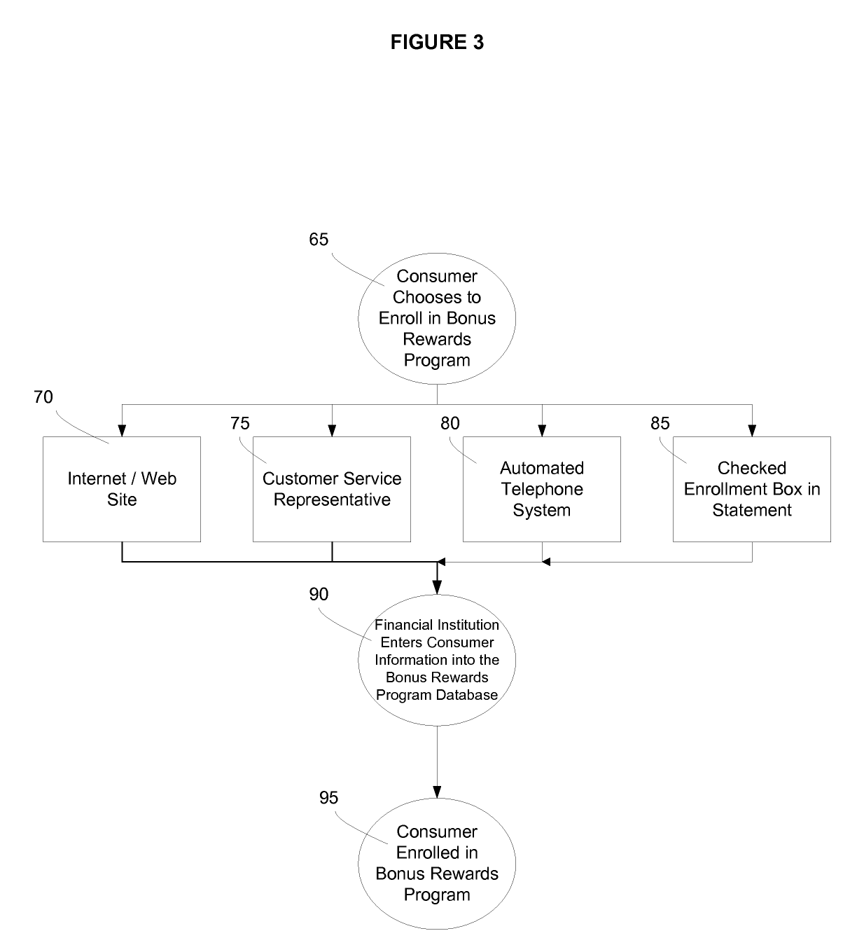

FIG. 1 is a flow diagram illustrating a method for enrolling in a series of bonus rewards programs, in accordance with an embodiment of the invention. It illustrates an example of some of the steps for a consumer to participate in one of the series of bonus rewards programs. First, a consumer enrolls in a bonus rewards program 20. The different ways in which a consumer may enroll will be further detailed in FIG. 3. Second, the consumer purchases goods and services from a category of merchants 25. Third, the consumer receives a bonus reward based on the value of the purchased goods and services from the merchants in the category 30. Finally, after some finite duration, the bonus rewards programs for the merchant category ends 35. However, at some point in time, the consumer may enroll in the next or another bonus program in the series of bonus rewards programs offered by the financial institution. In FIG. 1, the embodiment shows the consumer enrolling into the next bonus rewards program before the end of the present bonus rewards program 33. However, the consumer may enroll into the next bonus rewards program at any time. In some embodiments, the consumer enrolls anytime within one month prior to the commencement of the program.

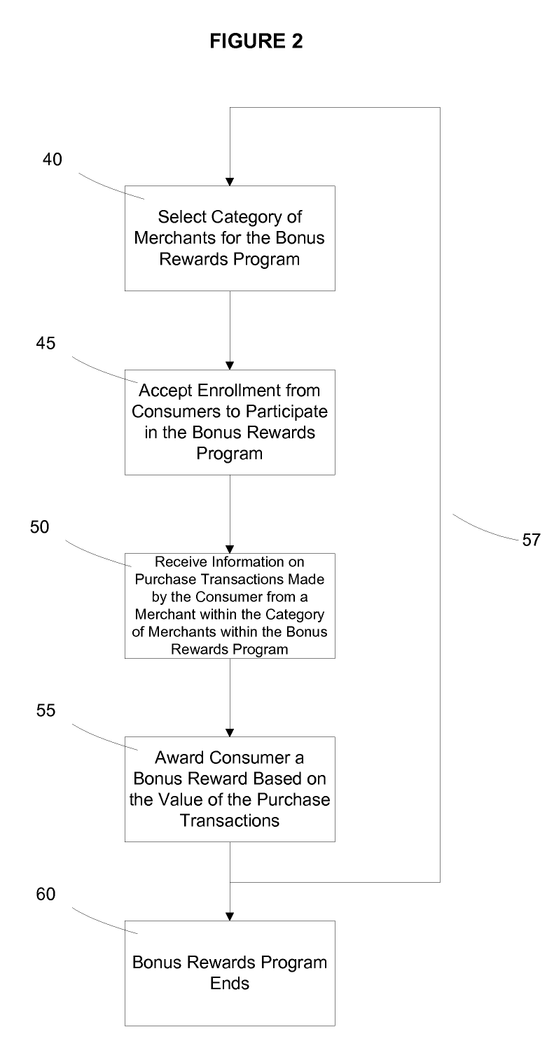

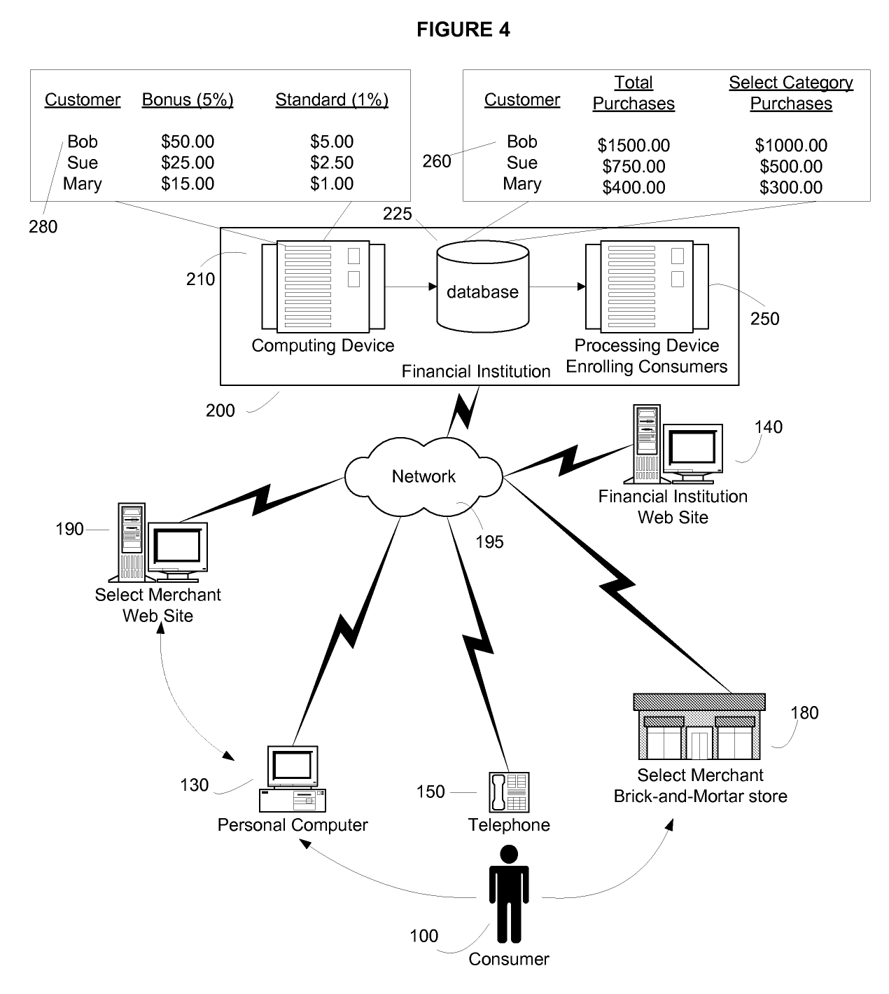

FIG. 2 is a flow diagram illustrating a method for accepting enrollment in a series of bonus rewards programs, in accordance with an embodiment of the invention. It is an example of some of the steps for a financial institution to offer one bonus rewards program in a series of programs to one or more consumers. First, the financial institution selects a category of merchants and/or one or more particular merchants for the bonus rewards program 40. Preferably, the financial institution selects the category of merchants and goods and services based on consumers needs for the given time frame of the bonus rewards program. For example, if the bonus rewards program is offered in the fall during the months of August and September, the category of merchants may include those that sell school supplies. This coincides with the start of the new school year and consumers' needs for new school supplies. Similarly, if a bonus rewards program is offered during the holiday season of November and December, then the category of merchants may include those that sell books and music. Again, this category of goods coincides with consumers' needs to buy popular holiday gifts. Yet another example may be when a bonus rewards program is offered in the spring and summer months, the financial institution may select merchants that offer consumers goods and services for home repair or décor. This category of merchants coincides with consumers' popular time of year to organize, decorate, or repair their homes. In the second step in the example of an embodiment in the present invention, the financial institution accepts the enrollment of consumers into the bonus rewards program 45. FIG. 4 will provide details of this function. Third, the financial institution receives information on the purchase transactions made by the consumer from the category of select merchants of the bonus rewards program 50. Fourth, the financial institution awards the consumer a bonus reward based on the value of the purchase transactions 55. Finally, the bonus rewards program ends according to the finite duration chosen by the financial institution prior to the start of (and informed to the each consumer enrolling into) the bonus rewards program 60. However, at some point in time, the financial institution selects the category of merchants for the next or another bonus rewards program in the series of bonus rewards programs. In FIG. 2, the embodiment shows the financial institution selecting the category of merchants of the next bonus rewards program before the end of the present bonus rewards program 57. However, the financial institution may select the category of merchants for the next bonus rewards program at any time. In some embodiments, the consumer enrolls anytime within one month prior to the commencement of the program.

In some embodiments of the invention, the bonus rewards available to a consumer during a bonus rewards period is capped. In this way, the financial institution limits its potential liability in awarding bonus rewards to consumers. The cap can vary from program to program, and can further be guaranteed to be at least some minimum value (e.g., $500), as an incentive for consumers to obtain and use that financial institution's credit card. Additionally, in an embodiment of the invention, selected offers for discounted services or merchandise are made to enrolled consumers. Preferably, the selected offers are in some way related to the merchant category being promoted in the bonus rewards program. In some embodiments, a selected offer is for free merchandise or services. For example, in a summer bonus rewards program promoting a merchant category of gasoline and outdoor entertainment (zoos, theme parks, water parks, etc.), an offer can be included for free photograph developing by a national drugstore chain. As another example, an offer for free shipping for online purchases may be made from selected merchants or sub-categories of merchants during a bonus rewards program active during the November-December holiday season. These offers can be conveyed to the consumer through any suitable medium, such as mail or e-mail. The offers are preferably funded directly by particular merchants or sub-categories of merchants who use the offers to direct business to their establishments. In one embodiment, the offer is a surprise that is not advertised to the consumer prior to enrollment in the bonus rewards program.

FIG. 3 is a flow diagram contemplating different ways for both a consumer to enroll, and a financial institution to accept enrollment, into a series of bonus rewards programs. In particular, it illustrates an embodiment of some of the different ways in which a consumer may enroll, and a financial institution may accept enrollment, into a bonus rewards program. First, a consumer chooses to enroll into a bonus rewards program 65. Next, the financial institution provides any of several ways for the consumer to enroll. These include enrolling through the financial institution's (or a merchant's) website 70, using the telephone by enrolling with a customer service representative 75, an automated telephone system 80, mail, electronic mail or other medium. Typically, the consumer receives a notification from the financial institution 85 in her monthly statement, which informs the consumer of enrollment vehicle options. Next, the financial institution receives the consumer information and enters it into a bonus rewards program database 90. Lastly, the consumer is enrolled into the bonus rewards program 95. In some embodiments, a small percentage of cardholders are automatically enrolled into one or more of the series of bonus programs, based on certain selection criteria. For example, new cardholders can be enrolled into a bonus rewards program automatically by the financial institution. Other cardholders can be automatically enrolled into particular bonus rewards programs corresponding to their demography, spending patterns, identified interests, etc.

FIG. 4 is a general overview of the operation of a method and system contemplated by an embodiment of the present invention. First, as mentioned in FIG. 2, the financial institution selects the categories of merchants and/or particular merchants before the start of each bonus rewards program. Next, as illustrated in FIGS. 1-3, a consumer 100 enrolls in each of the series of bonus programs (one at a time) offered by a financial institution 200. The consumer 100 preferably has several different ways to enroll in the series of bonus programs. One way she may enroll is through the financial institution's (or a merchant's) website 140 using her personal computer 130. A second way she may enroll is by using the telephone 150, either through an automated telephone system, or by a live operator. A third way a consumer 100 may enroll is by checking the “bonus rewards program enrollment” box on her statement and mailing it to the financial institution 200. Any number of other vehicles can also be made available for enrollment, such as those discussed above. Once a consumer 100 enrolls into a bonus rewards program, the financial institution 200 receives, processes, enrolls 250 the consumer 100, and places her information into the bonus rewards program database 225. After enrolling in the bonus rewards program, consumers 100 can purchase goods and services using their credit card (issued by the financial institution) from select merchants to accumulate bonus rewards. For example, referring to FIG. 4, a consumer 100 may make purchases from select merchants from the merchant's brick and mortar store 180, or using a personal computer 130 to purchase goods and services from the select merchant's website 190. As the consumer 100 makes purchases during the time frame of the bonus rewards program, the select merchants provide the financial institution 200 with the consumer's purchase information through its network 195. This information is preferably stored within the financial institution's bonus rewards program database 225. At the certain times (selected by the financial institution before the start of each bonus rewards program) throughout the bonus rewards program, the financial institution computes 210 the bonus reward and standard reward for each consumer.

Again, referring to FIG. 4, Consumer Bob 260 makes his total purchases using the financial institution's credit card of $1,500.00. Of those $1,500.00 worth of purchases, $1,000.00 are from select merchants of the bonus rewards programs. The financial institution then computes 210 both the bonus reward and the standard reward for Consumer Bob 280. In this embodiment, the bonus reward is 5% cash on all purchases from select merchants, while the standard reward is a different amount, for example, 1% cash of all other purchases. Although in this embodiment the bonus and standard rewards are in the form of cash, rewards can take any of several forms including but not limited to cash, account credit, increased value on merchant partner gift cards, points, or miles in frequent flyer programs. Therefore, in this embodiment, Consumer Bob will earn $50.00 in bonus rewards and $5.00 in standard rewards, for a total reward of $55.00. If the financial institution did not provide a bonus rewards program but only a standard reward for all purchases totaling $1,500.00, then Consumer Bob will only receive 1% or only $15.00 in cash rewards. If the financial institution has capped the bonus rewards program to, for example, $600, then only $600 of the $1,000 spent at the select merchants would be eligible for the bonus rewards but the other $400 would still be eligible for standard rewards. In this instance, Consumer Bob's $1,500 purchase would earn $30 in bonus rewards and $9 in standard rewards. Hence, the increase in bonus rewards provides consumers incentives to use the financial institution's credit card.

In some embodiments, the standard reward rate is variable, e.g., 0.25% for the first $1,500 of purchases, 0.5% for the next $1,500 of purchases, and 1% thereafter. Purchases receiving bonus rewards may be counted toward the accumulation for determining the standard reward rate. Alternatively, purchases receiving bonus rewards may not be counted toward such accumulation.

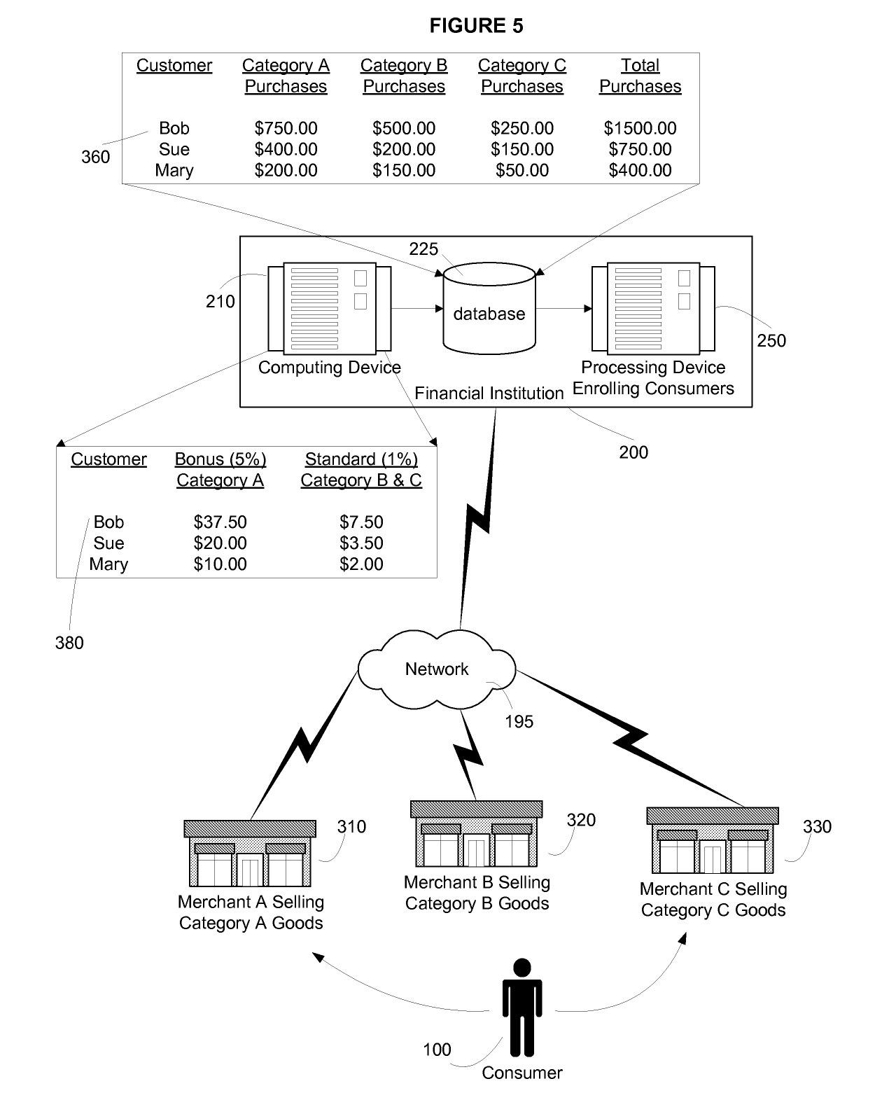

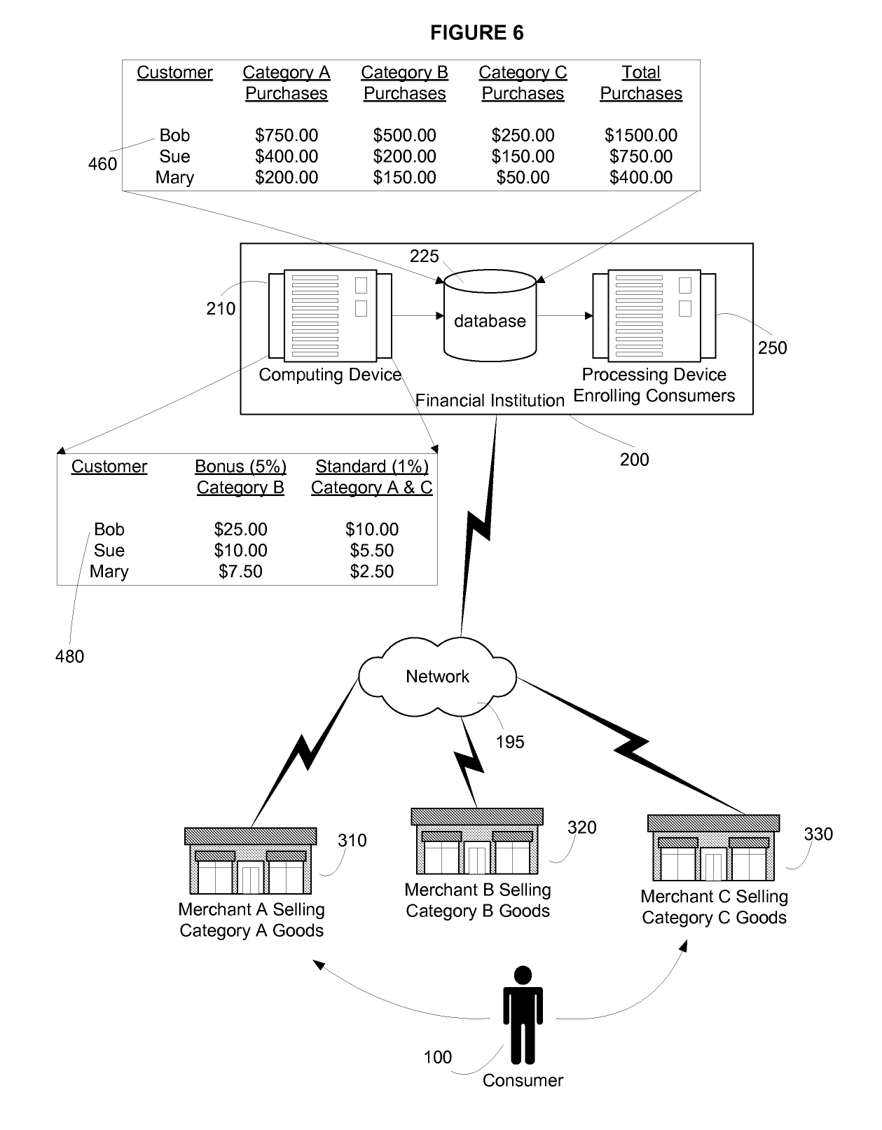

FIG. 5 is a general overview of the operation of a method and system contemplated by another embodiment of the present invention. FIGS. 5 and 6 illustrate the changes in bonus rewards to consumer as the category of select merchants change from one bonus rewards program to the next. For example, as shown in FIG. 5, a consumer 100 purchases goods and services from three merchants, Merchant A 310, Merchant B 320, and Merchant C 330 each are selling a different category of goods and services. These purchase transactions are sent from the merchant to the financial institution 200, processed 250, and then recorded into the bonus rewards program database 225. Looking at the example of Consumer Bob 360, he has made a $750.00 of category A purchases, $500.00 of category B purchases, and $250.00 of category C purchases, for a total of $1,500.00 worth of purchases. In this embodiment, suppose the financial institution 200 selected category A purchases as those eligible for bonus rewards to the consumer for the current bonus rewards program. With the bonus reward being 5% cash on all select purchases, and a standard reward of only 1% cash on all other purchases, the financial institution would compute 210 that Consumer Bob 380 would earn $37.50 in bonus rewards, and $7.50 for his other purchases. Again, although in this embodiment the bonus and standard rewards are in the form of cash, rewards can take any of several forms including cash, account credit, increased value on merchant partner gift cards, points, or miles in frequent flyer programs.

FIG. 6 is a general overview of the operation of a method and system contemplated by another embodiment of the present invention. Comparing FIG. 5 to FIG. 6, the financial institution 200 has now selected category B merchants as those that earn consumers bonus rewards. Continuing to use Consumer Bob 460 as an example, FIG. 6 shows he has made the same amount of purchases as in FIG. 5. Namely, that he has made a $750.00 of category A purchases, $500.00 of category B purchases, and $250.00 of category C purchases, for a total of $1,500.00 worth of purchases. However, because the financial institution has selected category B as its selected merchants for this bonus rewards program, Consumer Bob 480 earns $25.00 in bonus rewards, and $10.00 in standard rewards. Therefore, the selection of different merchant categories for each bonus rewards program creates incentives for consumers to purchase goods and services from those merchants during that program's time frame. This attracts more merchants to participate in the financial institution's bonus rewards programs, hence creating a wider network of merchants to accept its credit card. This in turn will provide incentives for consumers to use the credit card. Increased credit card use translates into profits for the financial institution through the fees it charges to merchants participating in the bonus rewards programs or by the interest it charges to customers on outstanding credit card account balances.

In some embodiments, enrollment in the bonus rewards programs is limited to cardholders of particular card types. For example, cardholders with “gas” or “miles” cards, for which additional rewards are already given, may be excluded from participation in the bonus rewards programs.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non- claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for using a financial alternative to currency to participate in one or more bonus rewards programs offered by a financial institution, the bonus rewards programs being offered in addition to a standard rewards program, the method comprising:
enrolling in a first bonus rewards program of a plurality of sequential bonus rewards programs offered by the financial institution, the first bonus rewards program being associated with a first category of merchants;
purchasing goods or services, using the financial alternative to currency, from a merchant within the first category of merchants; and
receiving a bonus reward from the financial institution based on the value of the purchased goods or services;
wherein the reward received for the purchases under the first bonus rewards program is of a greater value than a reward received for the purchase under the standard rewards program.

2. The method of claim 1 wherein each bonus rewards program in the plurality of sequential bonus rewards programs has a finite duration.

3. The method of claim 1, wherein the financial alternative to currency is a credit card.

4. The method of claim 1, wherein enrolling comprises the use of one or more of the following: the Internet; electronic mail; an automated interactive phone enrolling system; a live human operator over the phone; or the mail.

5. The method of claim 1, wherein the bonus rewards programs each last in duration for about three months.

6. The method of claim 1, wherein the first bonus rewards program contains at least one offer for discounted merchandise from merchants within the first category.

7. The method of claim 6, wherein the offers for discounted merchandise comprises at least one offer of free merchandise.

8. The method of claim 1, wherein the amount of bonus rewards received for the first bonus rewards program is capped.

9. A method implementing a bonus rewards program to one or more consumers for using a financial alternative to currency offered by a financial institution, the bonus rewards program being implemented in addition to a standard rewards program, the method comprising:
determining a first category of merchants to associate with a first bonus rewards program of a plurality of sequential bonus rewards programs;
accepting enrollment from a consumer to participate in the first bonus rewards program;
receiving information corresponding to a purchase transaction made by the consumer with the financial alternative to currency at a merchant within the first category of merchants; and
awarding the consumer with a bonus reward based on the value of the purchase transaction;
wherein the reward awarded for the purchase under the first bonus rewards program is a greater value than a reward awarded for the purchase under the standard rewards program.

10. The method of claim 9, wherein each bonus reward program in the plurality of sequential bonus rewards programs has a finite duration.

11. The method of claim 9, wherein the financial alternative to currency is a credit card.

12. The method of claim 9, wherein determining the first category of merchants comprises determining categories of merchandise that consumers typically purchase during the time of year the first bonus rewards programs is to be offered.

13. The method of claim 9, wherein accepting enrollment is performed automatically for selected consumers based on predetermined criteria.

14. The method of claim 9, wherein the bonus rewards programs each last in duration for about 3 months.

15. The method of claim 9, wherein the first category of merchants comprises about 3 to about 5 sub-categories.

16. The method of claim 9, wherein the first bonus rewards program contains at least one offer for discounted merchandise or services from merchants within the first category.

17. The method of claim 16, wherein the offer for discounted merchandise comprises at least one offer of free merchandise.

18. The method of claim 9, wherein the amount of bonus rewards awarded to the consumer for the first bonus rewards program is capped.

19. A system for implementing a series of bonus rewards programs, each bonus rewards program being offered to one or more consumers for using a financial alternative to currency offered by a financial institution, the bonus rewards program being implemented in addition to a standard rewards program, the system comprising:
a network of merchants comprising a plurality of categories of merchants;
a program sequencer for:
selecting a first category of merchants from the plurality of categories for a first bonus rewards program;
determining an active timeframe for the first bonus rewards program;
selecting a second category of merchants from the plurality of categories for a second bonus rewards program; and
determining an active timeframe for the second bonus rewards program, the active timeframe of the second bonus rewards program disjoint from the active timeframe for the first bonus rewards program;
an enrollment engine for accepting enrollment from consumers into the first bonus rewards program;
a database containing purchasing transaction information for consumers enrolled in the first bonus rewards program and the standard rewards program; and
a rewards processing engine for determining that a purchase transaction was made by an enrolled consumer at a merchant in the first category of merchants during the active timeframe of the first bonus rewards program, and for awarding bonus rewards based on the purchase transaction value, the bonus rewards value exceeding the value of rewards under the standard rewards program.

20. The system of claim 19, wherein the program sequencer is further for selecting the first and second categories of merchants based on merchandise that consumers typically purchase during the active timeframes for the first and second bonus rewards programs.
